(19) United States
(12) Patent Application Publication
(10) Pub. No.: US 2007/0118871 A1
(43) Pub. Date: May 24, 2007

(54) Method and system for recording a medium from a "set top box" to a portable multimedia player-recorder

(75) Inventor: Henri Crohas, Verrieres Le Buisson (FR)

Correspondence Address: YOUNG & THOMPSON, 745 SOUTH 23RD STREET, 2ND FLOOR, ARLINGTON, VA, 22202, US

(73) Assignee: ARCHOS, IGNY (FR)

(21) Appl. No.: 11/604,027

(22) Filed: Nov. 24, 2006

(30) Foreign Application Priority Data
Nov. 24, 2005 (FR) 05 11915

(51) Int. Cl. G06F 13/00; H04N 7/16; H04N 7/173; H04N 5/445

(52) U.S. Cl. 725/134; 725/29; 725/88; 725/102; 725/142; 725/46

(57) ABSTRACT

The invention relates to a method for recording a medium from a terminal receiving multimedia signals of the “Set Top Box” type to a portable player-recorder. The method according to the invention comprises the following stages: identification of a time slot in which said medium is accessible within the terminal, transmission of the settings for recording said medium to the player-recorder by means of a digital link between said terminal and the player-recorder; transmission of the medium to the player-recorder for a real-time recording by the player-recorder; the medium being transmitted via a media link separate from the link for transmission of the settings. In particular, the digital link is a serial link allowing the transmission of editorial data relating to the recorded medium.

This invention relates to a method and a system for recording a medium such as a video, from a terminal such as a “Set Top Box” to a portable multimedia player-recorder.

A “Set Top Box” type terminal is a terminal such as a satellite, cable, ADSL decoder, etc., for reception in particular of television signals. Such a terminal is generally connected to a television set on which television or radio programs and shows are broadcast. This terminal can also be connected, in a conventional manner, to other devices for broadcasting media (video, audio, data).

The portable multimedia player-recorder is a portable, hand-held device, capable of audio and video recording and broadcasting. It is conventionally equipped with a screen, speakers, storage means and software means. Such a device is for example one of the ARCHOS® brand players (AV700®, etc.). Generally, such a portable multimedia player is associated with a cradle for receiving the player in order to charge the batteries and/or in order to allow a connection to other devices such as a terminal of the Set Top Box type.

In order to allow a recording from the non-recording terminal to the portable player, it is necessary to solve the problem of synchronization of the two devices.

Systems are known in which the terminal controls the portable player by sending analogue control signals in frames of the analogue video signal, these frames are invisible in the image. Such systems are still complex to implement and offer limited communication between the portable player and the terminal.

A purpose of the present invention is to propose a new recording system which is simple to implement and simple to use.

Another purpose of the invention is to improve the communication between the terminal and the portable player.

Another purpose of the present invention is also a recording method allowing the commands sent by the terminal to be enriched.

At least one of the above-mentioned objectives is achieved with a method for recording a medium from a terminal for receiving multimedia signals of the “Set Top Box” type to a portable player-recorder, characterized in that it comprises the following stages:
identification of a time-slot during which said medium is accessible within the terminal,
transmission of the settings for recording said medium to the player-recorder using a digital link between said terminal and the player-recorder;
transmission of the medium to the player-recorder for a real-time recording by the player-recorder; the medium being transmitted via a media link separate from the link for transmission of the settings.

The type of medium generally transmitted is a video or audio signal of a television or radio show.

The invention is in particular remarkable due to the fact that it proposes transferring settings or controls in digital form, therefore very reliably, via a channel separate from the channel for transfer of the video signal.

Link means here a logical link permitting communication between two units. Transfer channel means here a material or virtual channel that can be carried alone or with other distinct transfer channels on a same physical link. The distinction between the links can thus be a purely logical distinction. The media can be either analogous or digital through a real or virtual channel.

Several virtual channels can share the same physical communication means. For example, the same Wifi connection can be used for transmitting the distinct virtual channel for the media and the virtual channel for the settings. In another example, the same USB or “FireWire” (IEEE1394) can be used for transmitting both the virtual channels of the media and of the settings.

With the method according to the invention, the settings for recordings are transmitted over a channel different from that for transmission of the medium, which is advantageously video. The video recording is programmed in the terminal, then the latter controls the recording in the player-recorder in real time or at a later time.

The fact of having a second digital communication channel between the terminal and the player-recorder makes it possible to transmit rich messages. In fact, according to the present invention the link for transmission of the settings can be a link based on a rich and structured protocol. It is possible in particular to include in the settings editorial or other information, relating to said media. Consequently, the term “settings” is to be considered in the broader sense. These settings can comprise controls for recording but also any other data in particular that relating to the medium to be recorded. The player-recorder comprises software means allowing the reception and the processing of the settings and optionally of the medium.

By way of example, these settings can advantageously comprise a real time “START” command controlling the start of the recording and a real time “STOP” command controlling the stopping of the recording. This embodiment is a real time mode in which the terminal retains complete control of the operations. In particular, the real time “START” command can be accompanied by a predetermined “TIMEOUT” stop command allowing the recording to be stopped after a predetermined time. This predetermined time can correspond to a fixed maximum duration independent of the medium and which serves to interrupt the recording when the player-recorder has not received the “STOP” command properly. This “TIMEOUT” can therefore be pre-set in the player-recorder. However, this predetermined “TIMEOUT” time can also correspond approximately to the duration of the broadcast of the media; in this case, the sending only of “START” and “TIMEOUT” can also be envisaged.

According to an advantageous variant of the invention, the settings include data relating to the time slot for the broadcast of the medium so as to allow the player-recorder to independently internally manage the period for recording the medium transmitted by the terminal. This mode consists of a deferred mode, i.e. the user programs one recording or a list of recordings in advance, the terminal transmits in particular time data relating to the start and to the duration of these recordings. When the medium is accessible in the terminal, by wireless, satellite, ADSL reception, etc., the player-recorder independently manages the recording. In order to do this, the terminal and the player-recorder comprise synchronized clocks. In this case, it is not necessary to transmit the “START” and “STOP” commands.

According to one embodiment of the invention, the identification of the time slot involves a programming of the recording using an electronic program guide (EPG) within the terminal. For the user, the time saving is considerable as he can use the usual program guide of the “Set Top Box” terminal on a television set in order to program the recording without having to operate the portable player-recorder.

The method according to the invention can also additionally comprise a regular update, from the terminal to the player-recorder, of the recording settings. This is particularly advantageous in the case of a program guide for which the television channels update information on program cancellations or time changes. The programming of the recording therefore does not remain fixed, it is dynamic because the link between the terminal and the player-recorder is dynamic.

According to an advantageous embodiment of the invention, the player-recorder records and secures the medium so as to allow a subsequent management of the digital rights. In order to secure the medium, it is possible to carry out a suitable encryption of said medium inside the player-recorder. The management of the digital rights in particular involves authorizing the broadcast of the medium only on this player-recorder, i.e. there is no possible transfer of content and/or of the read authority to other media players.

The settings can comprise a command for modifying the level of security of the medium. These security levels can correspond to disabled, decreased or increased security levels. In the case of a film for example, the rights to be authorized or denied are for example:
authorization or denial of authorization to export the film and the read authority to another portable video player, computer or any other video player; i.e. authorization or denial of authorization to transfer a content over an unprotected digital link;
authorization or denial of authorization to play the recorded content via a TV output of the player-recorder; i.e. authorization or denial of authorization to use a content over an unprotected analogue link;
authorization to use the film for a limited period of time; and
limited number of plays.

Preferably, the link for transmission of the settings is a serial link.

This link for transmission of the settings can be a hard-wired or wireless link such as Wifi or Bluetooth.

Moreover, this link for transmission of the settings can be a unidirectional link. In this case, it is possible to send the settings repeatedly in order to ensure greater reliability in the link. The link for transmission of the settings can also be a bidirectional link in particular allowing the confirmation, by the player-recorder, of the execution of the commands given by the terminal.

In addition to the above, in particular, the media link can be an analogue or digital link.

According to another feature of the invention, a system for recording a medium from a terminal receiving multimedia signals of the “Set Top Box” type to a portable player-recorder is proposed. According to the invention, the system comprises:
means for identifying a time slot in which said medium is accessible within the terminal,
a digital link between the terminal and the player-recorder for the transmission of the settings for recording the medium to the player-recorder;
a media link separate from the link for transmission of the settings for the transmission of the medium to the player-recorder for the purposes of a real-time recording by the player-recorder.

According to the invention, the player-recorder can be connected to the terminal in a direct manner or via a cradle through which the media link and the link for transmission of the settings pass.

Other advantages and characteristics of the invention will become apparent on examining the detailed description of one embodiment which is in no way limitative, and the attached drawings, in which:

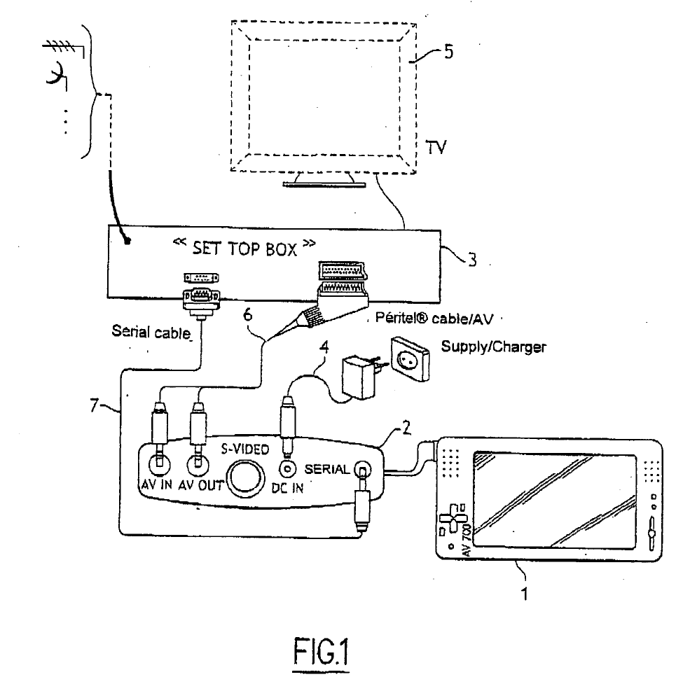

FIG. 1 is a diagram of the system according to the invention;

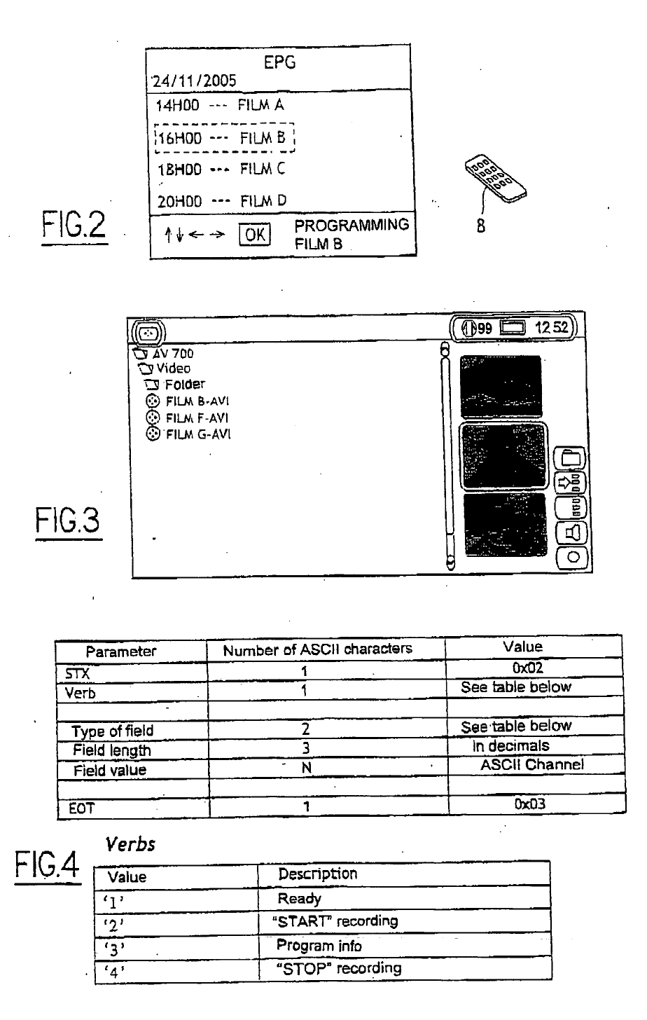

FIG. 2 is a diagrammatic view of a program guide;

FIG. 3 is a simplified view of a navigation window in the portable player; and

FIG. 4 is a summary of an example of the syntax of the serial link's communications protocol.

FIG. 1 shows a portable player 1 of the AV700 type of the ARCHOS brand, which is a portable multimedia player equipped with video recording and playing means in particular. The player's storage means are sufficiently large to be able to store several hours of programs. This portable player is connected to a cradle 2 equipped with connection means which can allow the portable player 1 to communicate with a terminal 3 of the Set Top Box type. Generally, the cradle 2 can serve as a battery charger for the portable player 1. The cradle comprises a “DC IN” input for an electric current supply via a power cable 4.

The terminal 3 can be a TV decoder equipped in a conventional manner for receiving TV signals originating from a wireless antenna, a satellite dish, a cable or ADSL via the telephone line, etc. This terminal 3 is connected to a television set 5 in a conventional manner. The system according to the invention comprises two links between the cradle 2 and the terminal 3. The first link 6 is an analogue video link via a péritel® or SCART connector. One end of the cable 6 comprises a péritel® plug connected to the terminal 3 the other end comprising two RCA plugs connected to two connectors “AV IN” and “AV OUT” on the cradle. This link 6 allows the transmission of the video signal from the terminal 3 to the portable player 1 via the cradle 2.

The second link 7 is a digital serial link allowing the communication between the terminal and the portable player via the cradle 2. The link 7 therefore allows a digital, bidirectional communication, with a rich content.

With such a system, the user can record several hours of programs chosen by a single click on the program guide of the terminal 2. The user can then take the recorded programs away with him and watch them on the screen of the portable player or on a television set while on the move.

Software means are used in the devices for correct implementation of the method according to the invention.

The figure diagrammatically illustrates an electronic program guide (EPG) in which it is possible to program the recording of a film to an external device, in this instance to the portable player 1. Thus by simply programming its recording in the program guide, the terminal then proceeds to communicate the necessary elements to the portable player 1. The user therefore no longer needs to program two devices. The programming of the recording in the program guide is simply carried out from a remote control 8 with which a film, for example film B, and the recipient device, i.e. the portable player 1 are selected. When the time comes, the terminal 3 will automatically trigger the recording of film B on the portable player 1 by sending in real time the instructions for starting and stopping the recording via the digital link 7; film B passing via the video link 6. It is possible to envisage programming on a weekly basis. The terminal can also send a video series to be recorded in advance. The player then receives for example the starting and finishing times and is responsible for automatically activating itself when the time comes in order to carry out the recording at the right time.

The information transmitted by the terminal 3 to the portable player can be editorial information on the program to be recorded, such as the number of the channel broadcasting the program, the title of the program, a description of the program, the type of program, etc. This information is used in the portable player in order to:
name the recording file;
add this information as metadata to the recorded file, this information being able to be the name of the producer, the type of program, the names of the actors, a description, an editor's note, etc;
present the video content to the user in categories; “talk show” type recordings, adventure films, etc.

In FIG. 3, a navigation window is seen in the portable player 1. The recorded film B is listed in a folder.

FIG. 4 shows a summary in the form of tables of the syntax of the communications protocol between the terminal 3 and the portable player via the digital link 7. This illustration shows that it is a rich and structured protocol. The structure of a packet is seen, each packet starting with “STX” (for “start of text”) and ending with “EOT” (“end of text”).

Of course, the invention is not limited to the examples which have just been described and numerous adjustments can be made to these examples without exceeding the scope of the invention. Particularly, “Set Top Box”means here any entity that, considered alone or in combination, constitutes a media source. This entity can access, via an adaptor or directly, to local or remote media servers. This entity can be an adaptor for television on IP, an ADSL box, a computer used as a multimedia server or generally any remote server connected to the portable player directly or indirectly by wired means (as cables), wireless (as Wimax) or means using optic fibers. Furthermore, Means used for recording can also advantageously be used for playing again at least implemented records, and more generally any media stored in the portable player-recorder.

1. Method for recording a medium from a terminal for receiving multimedia signals of the “Set Top Box” type to a portable player-recorder, characterized in that it comprises the following stages:
identification of a time slot in which said medium is accessible within the terminal,
transmission of the settings for recording said medium to the player-recorder using a digital link between said terminal and the player-recorder;
transmission of the medium to the player-recorder for a real-time recording by the player-recorder; the medium being transmitted via a media link separate from the link for transmission of the settings.

2. Method according to claim 1, characterized in that the link for transmission of the settings is a link based on a rich and structured protocol.

3. Method according to claim 2, characterized in that the settings include editorial information relating to said medium.

4. Method according claim 1, characterized in that the identification of the time slot involves a programming of the recording using an electronic program guide within the terminal.

5. Method according to claim 1, characterized in that it also comprises a regular update of the recording settings, from the terminal to the player-recorder.

6. Method according to claim 1, characterized in that the settings include a real-time “START” command controlling the start of the recording and a real-time “STOP” command controlling the stopping of the recording.

7. Method according to claim 1, characterized in that the settings include, together with a real-time “START” command controlling the start of the recording, a predetermined “TIMEOUT” stop command allowing the recording to be stopped after a predetermined time.

8. Method according to claim 1, characterized in that the settings comprise data relating to the time slot for the broadcast of the media so as to allow the player-recorder to independently internally manage the period for recording the medium transmitted by the terminal.

9. Method according to claim 1, characterized in that the player-recorder records and secures the medium so as to allow a subsequent management of the digital rights.

10. Method according to claim 9, characterized in that, in order to secure the medium, an encryption of said medium is carried out.

11. Method according to claim 9, characterized in that the settings include a command for modifying the security level of the medium.

12. Method according to claim 1, characterized in that the link for transmission of the settings is a serial link.

13. Method according to claim 1, characterized in that the link for transmission of the settings is a hard-wired link.

14. Method according to claim 1, characterized in that the link for transmission of the settings is a wireless link.

15. Method according to claim 1, characterized in that the link for transmission of the settings is a unidirectional link.

16. Method according to claim 15, characterized in that said settings are sent repeatedly.

17. Method according to claim 1, characterized in that the link for transmission of the settings is a bidirectional link.

18. Method according to claim 1, characterized in that the media link is an analogue link.

19. Method according to claim 1, characterized in that the media link is a digital link.

20. Method according to claim 1, characterized in that the player-recorder is connected to a cradle via which the media link and the link for transmission of the settings pass.

21. System for recording a medium from a terminal receiving multimedia signals of the “Set Top Box” type to a portable player-recorder, characterized in that it comprises:
means for identifying a time slot in which said medium is accessible within the terminal,
a digital link between the terminal and the player-recorder for the transmission of the settings for recording the medium to the player-recorder;
a media link separate from the link for transmission of the settings for the transmission of the media to the player-recorder for the purposes of a real-time recording by the player-recorder.

22. System according to claim 21, characterized in that the link for transmission of the settings is a serial link.

23. System according to claim 21, characterized in that the link for transmission of the settings is a hard-wired link.

24. System according to claim 21, characterized in that the link for transmission of the settings is a wireless link.

25. System according to claim 21, characterized in that the link for transmission of the settings is a unidirectional link.

26. System according to claim 21, characterized in that the link for transmission of the settings is a bidirectional link.

27. System according to claim 21, characterized in that the media link is an analogue link.

28. System according to claim 21, characterized in that the media link is a digital link.
